(19) United States
(12) Patent Application Publication
(10) Pub. No.: US 2024/0051450 A1
(43) Pub. Date: Feb. 15, 2024

(54) Vehicle-Mounted Hose Reel With Pivotal And Traversing Capability

(71) Applicant: Vac-Con, Inc., Green Cove Springs, FL (US)

(72) Inventors: Todd Masley, St. Augustine, FL (US); Bryce Rieger, Ponte Vedra, FL (US); Nathaniel Fischer, Jacksonville, FL (US); Iain Specht, Jacksonville, FL (US); Michael Duell, Green Cove Springs, FL (US)

(73) Assignee: Vac-Con, Inc., Green Cove Springs, FL (US)

(21) Appl. No.: 18/271,081

(22) PCT Filed: Jan. 6, 2022
(86) PCT No.: PCT/US2022/011445

§ 371 Date: Jul. 6, 2023

Related U.S. Application Data
(60) Provisional application No. 63/272,782, filed on Oct. 28, 2021.
(60) Provisional application No. 63/134,441, filed on Jan. 6, 2021.

(51) Int. Cl. B60P 3/035; B65H 75/42; E03F 9/00; B08B 9/032; B08B 9/035; B08B 13/00

(52) U.S. Cl. CPC B60P 3/035; B65H 75/425; E03F 9/007; B08B 9/0321; B08B 9/035; B08B 13/00; B65H 2402/32; B65H 2701/33; B08B 2209/032

(57) ABSTRACT

A combination vehicle (10) for cleaning a sewer includes a water jetting system (12) with a frame (34) mounted to a first end (38) of the vehicle (10) and horizontally spanning substantially the width thereof, and a slide carriage (36) operatively engaged with the frame (34) and slideable therealong. A hose reel frame (28) pivotally connects to the slide carriage (36) and is pivotal about a vertical axis, and supports a hose reel (30) that is rotatable about a horizontal axis and configured to support a hose (32). The hose (32) operatively connects to a water jetting source (46) to supply pressurized water for use in cleaning the sewer. A controller (44) operatively connects to the hose reel frame (28) and is operable to move the slide carriage (36) along the frame (34), and also to pivot the hose reel frame (28) relative to the vertical axis, thereby to enhance safety and maneuverability in locating the hose (32) in a desired position for cleaning a sewer.

### CROSS-REFERENCE TO RELATED APPLICATION

The present application claims priority under Section 120 to U.S. Provisional Patent Application Ser. No. 63/134,441, filed Jan. 6, 2021, and to U.S. Provisional Patent Application Ser. No. 63/272,782, filed Oct. 28, 2021, each of which is expressly incorporated by reference herein in its entirety.

### FIELD OF THE INVENTION

The present invention relates to a combination vehicle that includes a vacuum unit and a water jetting unit.

### BACKGROUND OF THE INVENTION

Utility vehicles used to maintain and clean sewer systems, sometimes referred to as combination vehicles, often include auxiliary equipment such as a jetting unit, or system, and/or a vacuuming unit, or system. Jetting, in particular, is a process in which a high-pressure water hose with a sewer-jetting nozzle is pushed through a manhole and into dirty pipeline of a sewer system. The high-pressure hose nozzle delivers high-pressure water to a sewer to dislodge and clear debris such as stones, bottles, grease, sludge and grime. Typically, these high-pressure water jetting units deliver water at a flow rate of 0-120 gallons per minute into the manhole and pipeline, and the force of the water pushes the debris out of the pipeline to a gully hole, for example. In the same jetting units, the nozzle is oriented rearwardly so that the water flow pushes the nozzle further forward into the pipeline. As the dirt and debris is removed from the sewer system, the nozzle and high-pressure hose may progress deeper into the sewer system to further flush out any dirt and debris. Once the pipeline has been cleared, the high-pressure hose is pulled out of the manhole and stored on a reel mounted to the vehicle.

The high-pressure hose of a jetting system is typically stored on a hose reel storage assembly that is mounted on the combination vehicle. Such hose reel storage assemblies generally include at least a hose reel for receiving and storing the high-pressure hose and a support structure, or frame, for mounting the hose reel to the vehicle. In this context, the term “hose reel” means a cylindrical spindle or drum in which hose is wound around for storage. Such hose reel storage assemblies are typically large and heavy because as much as one thousand feet of one-inch diameter (or greater) high-pressure hose may be required to maintain and clean large sewer systems. Because of this significant size and weight, hose reel storage assemblies are typically mounted to the combination vehicle with an attachment located at the front or rear of the vehicle. For example, U.S. Pat. No. 4,50,990 depicts a hose reel attached to the rear of a vehicle at a fixed location on the vehicle.

For sewer jetting operations, it is preferable to locate the hose reel directly over the manhole of the sewer system to be cleaned. This preferred placement of the hose reel is a direct result of the large and heavy nature of the hose reel and hose which makes it difficult to maneuver the hose any significant amount of distance. Thus, the workable space of a vehicle having a fixed hose reel storage system is dictated by the position of the vehicle relative to the sewer system manhole, especially in environments where the vehicle cannot drive directly over the manhole.

Other vehicle mounted hose reel storage assemblies have become known as well. For example, U.S. Pat. No. 5,241,181 discloses a hose reel storage system mounted to the front of a vehicle. The hose reel storage system is supported by a structure configured to tilt the hose reel toward or away from the hood of the vehicle. U.S. Pat. No. 6,059,241 is similar in that regard, but with the added capability of rotating the storage reel about the corresponding support structure.

U.S. Pat. No. Re. 34,585 also discloses a hose reel storage system mounted to the front of a vehicle. The hose reel storage system is capable of pivoting the hose reel about the support structure and moving the support structure in a direction toward or away from the vehicle. U.S. Pat. No. 5,636,648 is similar except that the hose reel storage system is mounted to the rear of the vehicle.

These hose storage systems described above only provide for a limited degree of movement of the hose storage reel relative to the vehicle. In this regard, the ability of an operator to locate the hose reel over a manhole is still dependent, primarily, upon the location of the sewer cleaning vehicle relative to the manhole. For example, if the sewer cleaning vehicle is positioned left (or right) of center relative to the manhole, the vehicle would have to be repositioned to allow the operator to locate the hose reel over the manhole.

Accordingly, it is an object of the present invention to facilitate the use of a vehicle mounted jetting system while overcoming current limitations with respect to vehicle maneuverability and positioning relative to a point of use for jetting system.

### SUMMARY OF THE INVENTION

The present invention achieves these objects by equipping a combination vehicle, in this case a sewer cleaning vehicle, with a water jetting system having a frame mounted to a first end of the vehicle and spanning substantially a width thereof and a slide carriage operatively engaged with the frame and slideable therealong, across a width of the vehicle. The jetting system further includes a hose reel frame pivotally connected to the slide carriage, a hose reel rotatably supported on the hose reel frame and configured to support a water supply line that is operatively connected to a jetting pump located on the combination vehicle, and a controller operatively coupled to the hose reel frame and operable to maneuver the slide carriage, hose reel, and hose reel frame.

The hose reel frame includes a first proximal end adjacent the pivot axis and a second distal end spaced from and which pivots about the pivot axis. The proximal end operatively connects to an actuator supported on the slide carriage, and the actuator defines a pivot axis of the hose reel frame. With this structure, a user may move the second distal end of the hose reel frame to a position that extends beyond a left or a right side of the combination vehicle.

To enable movement of the slide carriage along the frame, the frame includes a driven lead screw configured to threadably engage the slide carriage. Relative rotation of these two components causes the slide carriage to move along the frame, in either direction, and along the entire length of the frame.

The water jetting system includes a vision system with a connected display used to view a movement area of the hose reel frame relative to the first end of the vehicle. The vision system serves as a safety feature and also facilitates parking of the combination vehicle near the manhole and locating the hose reel over a manhole for jetting operations.

The controller operatively couples to the hose reel frame with a swing arm that permits movement of the controller relative to the hose reel frame, preferably both horizontal and vertical movement. This movability of the controller relative to the hose reel frame facilitates locating the controller in a preferred orientation relative to the manhole for jetting operations.

To lock the slide carriage in place relative to the frame, the hose reel frame further includes a locking mechanism. The locking mechanism prevents any traversing movement of the slide carriage relative to the frame while the vehicle is moving, for example.

The slide carriage has generally a C-shape in transverse cross section, made of upper and lower carriage assemblies configured to partially surround, and thereby to engage with and move along, respective upper and lower engagement members of the elongated frame. These components together provide four angled elongated surfaces via which roller bearings carried by the slide carriage contact corresponding engagement surfaces of the frame, to guide the traversing movement. Also, the upper carriage assembly preferably also includes a stabilizing roller bearing that rotates about a vertical axis and operatively engages with a back, or aft, surface of the frame, along a plane that is parallel with a front surface of the frame.

To adjust a position of the slide carriage relative to the frame, the slide carriage includes at least one tensioner. More particularly, the slide carriage includes a pair of spaced tensioners that are adjustable to control the relative vertical positions of the upper and lower carriage assemblies.

To facilitate routing of the water supply line, or hose, from the hose reel to the vehicle, the slide carriage includes a bulkhead plate. The water supply line is coupled to the bulkhead plate between the hose reel and the jetting pump. The hose reel frame further includes a hose tray to support the water supply line as it is routed from the hose reel frame to the bulkhead plate. The frame further includes a hose bundle support rod configured to freely support the water supply line as the slide carriage traverses the frame.

According to one preferred embodiment of the invention, a combination vehicle includes a jetting system and a jetting pump with enhanced maneuverability to make sewer cleaning safer and more convenient. The jetting system includes a frame configured to be coupled to the vehicle and a slide carriage operatively engaged with the frame and slideable along a length thereof. The jetting system further includes a hose reel frame pivotally connected to the slide carriage and a hose reel rotatably supported on the hose reel frame and configured to support a hose, i.e., a water supply line, connected to the jetting pump. The hose reel frame is movable linearly relative to the frame, in first or second directions, i.e., to the left or the right, relative to the vehicle, and also pivotally movable about the pivot axis relative to the slide carriage.

The jetting system further includes a controller operatively coupled to the slide carriage, the hose reel, and the hose reel frame. The controller enables a user to traverse the slide carriage along the frame to a desired position, to then pivot the hose reel frame to a desired orientation, or angle, relative to the vehicle, and also to rotate the hose reel to either unwind or wind the hose, as needed. This combination of capabilities enhances the user's ability to readily locate the jetting hose in a desired position relative to a manhole, for use in jetting operations.

Those skilled in the art will more readily appreciate and understand the features of the present invention when considered in the context of the accompanying drawings, which are briefly described in the next section and then described in more detail in the section thereafter.

### BRIEF DESCRIPTION OF THE DRAWINGS

FIG. 1 is a side view, partially schematic, of a combination vehicle according to a preferred embodiment of the present invention, a sewer cleaning vehicle equipped with a jetting system having a hose reel with pivotal and traversing capability.

FIG. 2 is a front view of the vehicle shown in FIG. 1.

FIG. 3A is a plan view of the front end of the same vehicle, with the hose reel in a stowed position, and showing a movement area of the hose reel relative to the front end of the vehicle.

FIG. 3B is another plan view of the front end of the same vehicle, similar to FIG. 3A, but enlarged.

Each of FIGS. 3C, 3D, and 3E is still another plan view of the front end of the same vehicle, similar to FIG. 3B, but with the hose reel in a: first pivoted position, traversed to the furthest passenger-side position; a second pivoted position, traversed to the furthest driver-side position; and a third pivoted position, traversed to a midpoint along the front end of the vehicle, respectively.

FIG. 4 is a perspective view of the jetting system for the vehicle shown in FIG. 1, and more particularly a hose reel, a hose reel frame, and a slide carriage to which the frame mounts.

FIG. 5 is a rear perspective view of the structure shown in FIG. 4, with the hose reel in a stowed position and mounted to the carriage.

FIG. 6 is a front perspective view of the structure shown in FIG. 5, in partial cross-section, showing additional details.

FIG. 7 is a side view of the structure shown in FIG. 5, showing the details of the slide carriage.

FIG. 8 is a side view of the slide carriage and frame of the jetting system, in partial cross-section, with the slide carriage removed from the frame.

FIG. 9 is a perspective view of the slide carriage.

FIG. 10A is a rear perspective view of the jetting system, showing the slide carriage drive system.

FIG. 10B is a rear perspective view of the jetting system, similar to FIG. 10A, but with the slide carriage removed from the frame.

FIG. 11 is a partial schematic side view of the jetting system, in partial cross-section, showing in broken lines the water supply line coupled between the hose reel and the vehicle via the slide carriage.

### DETAILED DESCRIPTION OF THE DRAWINGS

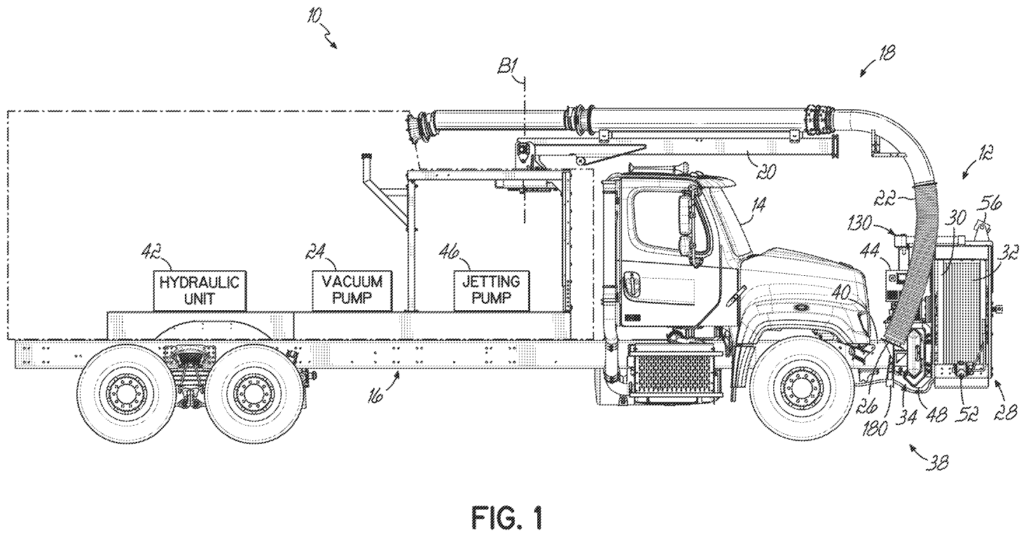

FIG. 1 shows a combination vehicle 10 with a jetting system 12 according to a preferred embodiment of the invention. The combination vehicle 10 includes a conventional cab 14 and a vehicle body 16 which includes the jetting system 12 and a vacuum system 18. In this context, “combination vehicle” means a vehicle including at least a high pressure water jetting system, but may also include vacuum capabilities. Also, although the features of the invention are illustrated and described in connection with a combination vehicle that also has vacuum capabilities in the form of a vacuum system, those skilled in the art will recognize that the invention may be used with a vehicle that has only water jetting capabilities.

The combination vehicle 10 includes a single engine hydrostatic drive in order to power the components of both the vacuum system 18 and the jetting system 12. Alternatively, the combination vehicle 10 may include a dual engine configuration, using the engine of the vehicle 10 to power the vacuum system 18 while a separate, auxiliary engine, powers the jetting system 12.

The vacuum system 18 of the combination vehicle 10 includes at least a telescopic boom 20, a suction hose 22, a vacuum pump 24, and other related equipment, such as a refuse tank (not shown), for example. As shown, the telescopic boom 20 is pivotally mounted to the vehicle body 14 and pivotable about a vertical axis B1 to allow movement of the connected suction hose 22 relative to the combination vehicle 10. When the boom 20 is not in use, such as when the combination vehicle 10 is traveling, the boom 20 is placed in a stowed position, as shown. When so positioned, a free end of the suction hose 22 may be coupled to a weldment 26 on the jetting system 12 to secure the suction hose 22 when not in use. More particularly, the weldment 26 is configured to secure the suction hose 22 to the jetting system 12 at a location that is away from the movement path of the components of the jetting system 12. The weldment 26 includes a receiving end that is positioned upright and configured to receive part of the suction hose 22 thereon for coupling thereto. The receiving end of the weldment 26 may be closely sized to the diameter of the suction hose 22, for example.

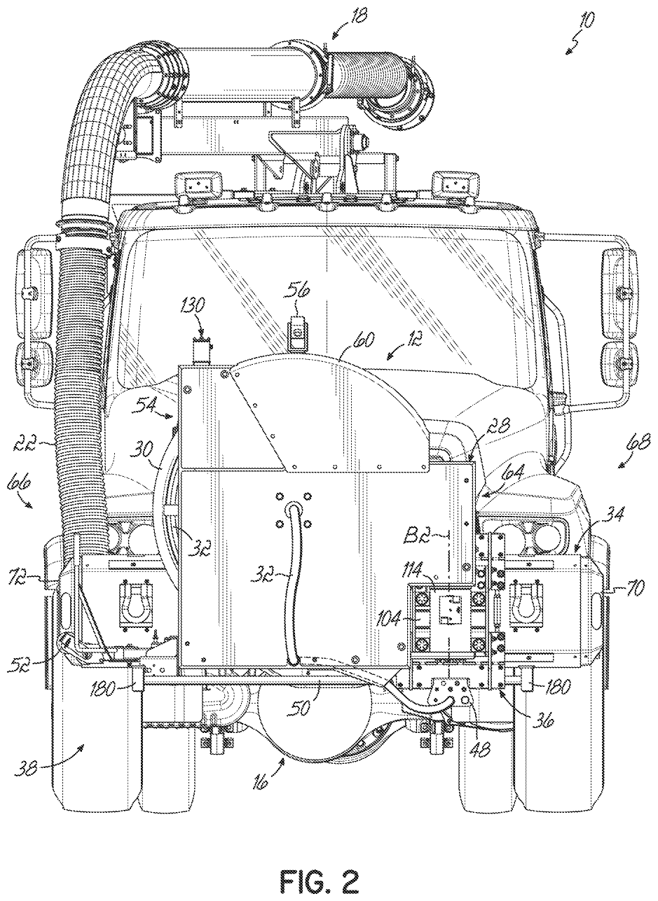

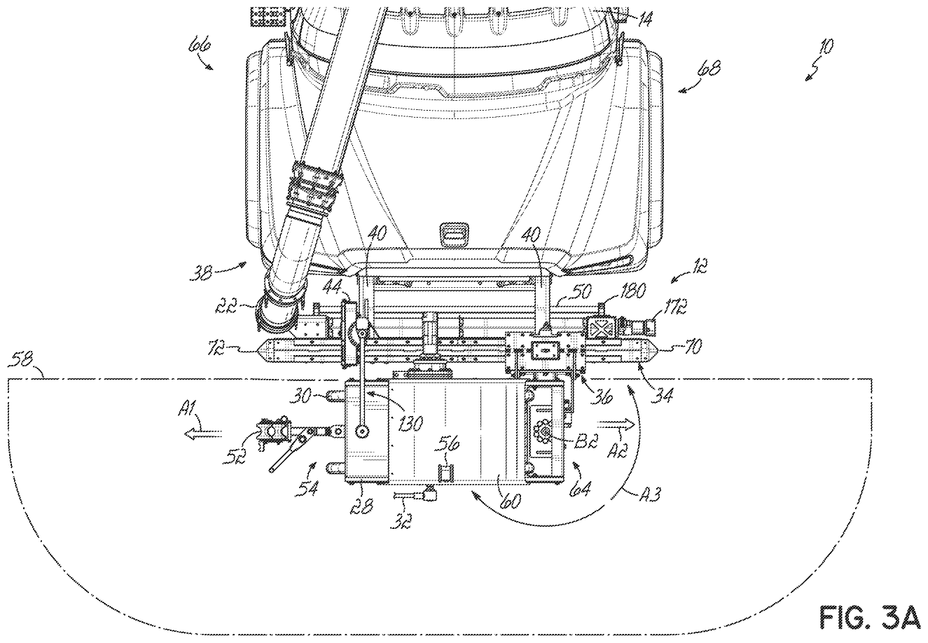

As shown in FIGS. 1 and 2, the jetting system 12 includes a hose reel frame 28 that rotatably supports a hose reel 30 (or hose drum) for storing a water supply line 32, such as a high-pressure hose. The hose reel frame 28 is supported from a frame 34 of the jetting system 12 via a slide carriage 36. More specifically, the frame 34 has a length that generally corresponds to a width of the vehicle 10 (i.e., the dimension of the vehicle 10 between the left and right sides) and is configured to attach to a mount structure extending from a front end 38 of the vehicle 10. As shown, the frame 34 attaches (e.g., by bolts or welds) directly to frame rails 40 that extend from the body 16 of the combination vehicle 10. The frame 34 is oriented in a horizontal plan. The slide carriage 36 slidably couples to the frame 34 and is movable therealong across the front of the vehicle 10. The slide carriage 34 supports and carries the hose reel frame 28. More particularly, the hose reel frame 28 pivotally couples to the slide carriage 36 so as to be movable between a stowed position, aligned with the front of the vehicle 10, and a position aligned perpendicular to the stow position, or any desired position therebetween. Because of the jetting system 12 structure, the hose reel 30 has both pivotal and traversing capability relative to the combination vehicle 10, as described in further detail below.

Components of the jetting system 12 are operatively coupled a hydraulic unit 42 located on the vehicle 10 such as one or more hydraulic pumps capable of providing a mechanical source of power for operating components of the jetting system 12. The mechanical source of power provided by the hydraulic unit 42 may cause the traversing and pivotal movements of the hose reel frame 28 and hose reel 30, as well as rotational movement of the hose reel 30 for winding/unwinding of the water supply line 32, for example. The jetting system 12 further includes a control assembly 44 moveably coupled to the hose reel frame 28 and configured to operate components of the jetting system 12, as will be described in further detail below.

In the embodiment shown, the jetting system 12 is located at the front end 38 of the vehicle 10. However, the jetting system 12, and more particularly the hose reel 30, may be located elsewhere on the combination vehicle 10. For example, the jetting system 12 may be located at either end (e.g., the front end 38 or the opposite, back end) of the combination vehicle 10, or on either side of the vehicle 10. The jetting system 12 may alternatively be mounted on a trailer or other mobile structure capable of locating the jetting system 12 adjacent a manhole.

The water supply line 32 of the jetting system 12 is operatively connected to a jetting pump 46 on the combination vehicle 10 for delivering high-pressure fluid (e.g., water) to the water supply line 32 for jetting operations. As shown in FIGS. 1 and 2, the water supply line 32 is routed from the hose reel 30 to a bulkhead plate 48 on the slide carriage 36. From the bulkhead plate 48, the water supply line 32 is draped over a hose bundle support rod 50 on the frame 34 and connected to the jetting pump 46 located on the combination vehicle 10. The bulkhead plate 48 and the hose bundle support rod 50 support the hose 32 above the ground and further prevent it from becoming tangled, kinked, or otherwise damaged during the pivoting and traversing movements of the hose reel 30. The jetting pump 46 may be a high-pressure pump such as positive displacement pump, rotary pump, reciprocating pump, centrifugal pump, or other suitable pump capable of delivering fluid at operating pressures of up to 5,000 pound-force per square inch (PSI), for example. In that regard, the water supply line 32 may further include a high-pressure nozzle for controlling the high-pressure release of fluid.

To facilitate winding and unwinding of the water supply line 32 in an organized manner from the hose reel 30, the jetting system 12 and more particularly the hose reel frame 28 includes a wind guide 52. The wind guide 52 is pivotally mounted to a distal end 54 of the hose reel frame 28. The wind guide 52 can pivot to either side of the hose reel frame 28 to facility winding and unwinding of the water supply line 32 from the hose reel 30. The pivot range of the wind guide 52 may be up to 180° relative to the distal end 54 of the hose reel frame 28, for example. In the embodiment shown, the wind guide 52 is a manual wind guide. Alternatively, the wind guide 52 could be powered by a motor, hydraulics, pneumatics, or other similar means. Further, the wind guide 52 may be slideable along the distal end 54 of the hose reel frame 28.

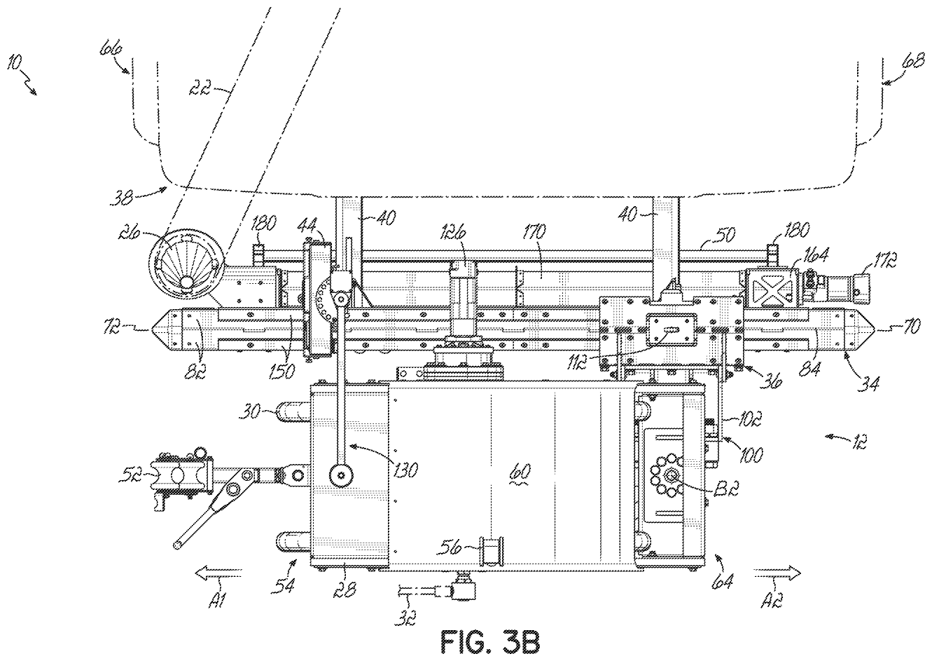

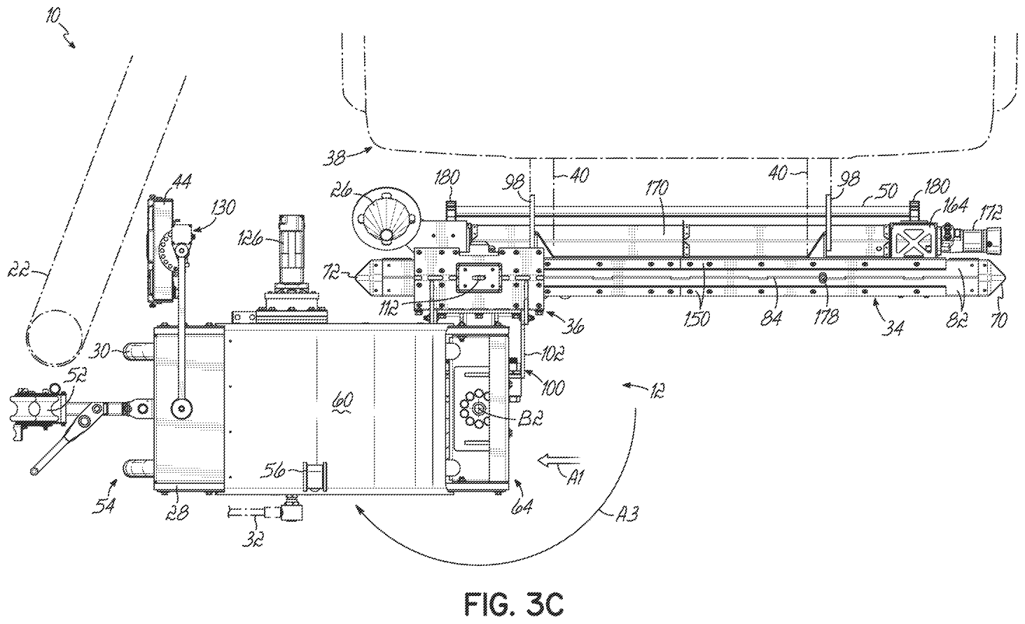

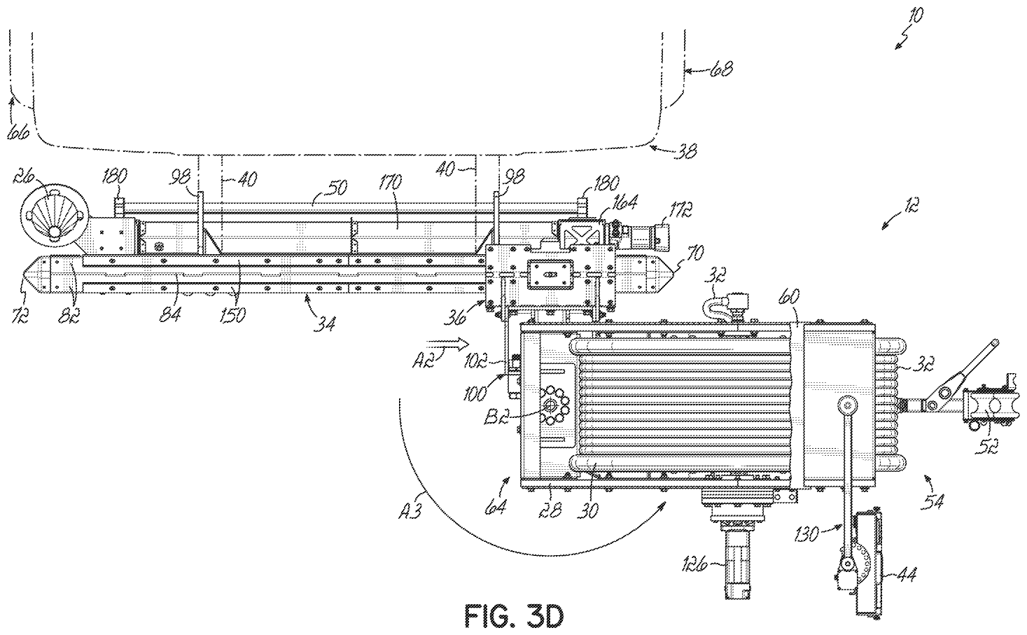

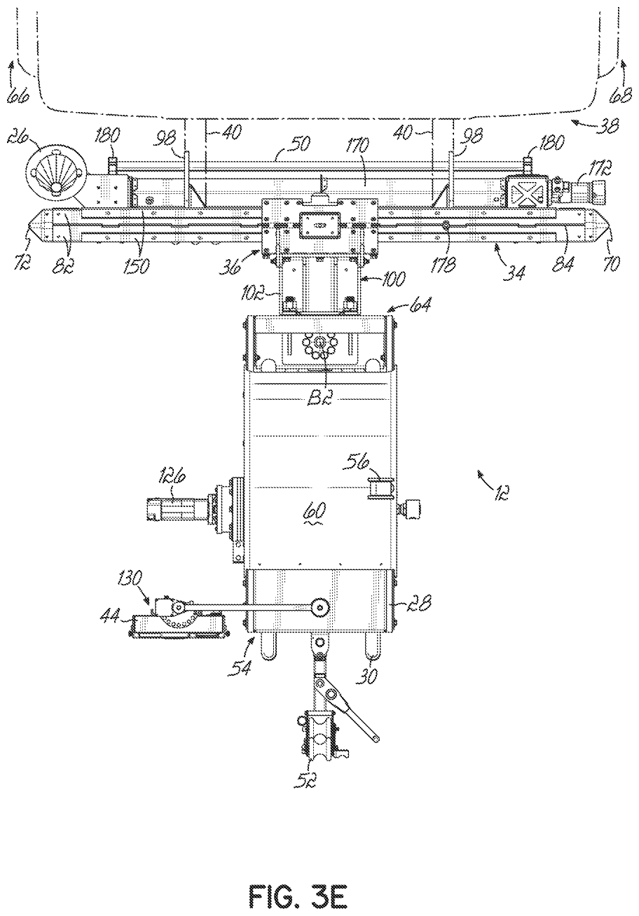

As shown in FIGS. 1 and 2, the jetting system 12 further includes a video camera 56, such as a wide-angle digital video camera, which is part of a vision system used by an operator of the combination vehicle 10 to view a movement area 58 (FIG. 3A) of the hose reel frame 28 relative to the front end 38 of the vehicle 10. The camera 56 is located on an integrated cover 60 of the hose reel frame 28 so as be facing outwardly, in a direction away from the front 38 of the vehicle 10, when the hose reel frame 28 is in a stowed position, as shown in at least FIGS. 1 and 2, for example. The video camera 56 is operatively coupled to one or more Human Machine Interface(s) (HMI) 62, in a wireless or wired manner, to display the movement area 58 thereon. For example, a portable HMI (not shown) may be located in the cab 14 of the vehicle 10 and another HMI 62 may located on the control assembly 44. In any event, the video camera 56 and one or more HMI(s) 62 define the vision system. Using an HMI 62, the combination vehicle 10 operator is able to view the movement area 58 of the hose reel frame 28 relative to the combination vehicle 10, which is superimposed on the surfaces directly in front of the vehicle 10 via the HMI 62 display (e.g., roadway or ground near a manhole to be jetted). That way, as the vehicle 10 approaches a manhole, for example, the movement area 58 can be seen to ensure that the vehicle 10 is appropriately positioned relative to the manhole so that the hose reel frame 28 and hose reel 30 can be located over the manhole. The vision system is also used to ensure that the movement area 58 is free of obstructions which might cause damage to, or be damaged by, movement of the hose reel frame 28. As such, the vision system serves as a safety feature and also facilitates parking of the combination vehicle 10 near the manhole and locating of the hose reel 30 and hose reel frame 28 over a manhole for jetting operations.

As shown in FIG. 3A, the movement area 58 is defined as a region of space relative to the front end 38 of the combination vehicle 10 in which the hose reel frame 28 and hose reel 30 may be moved. The traversing and pivoting capability of the jetting system 12 permit the hose reel frame 28 and hose reel 30 to be moved freely within the movement area 58. More particularly, the distal end 54 of the hose reel frame 28, where the nozzle of the hose 32 is located, may be moved to any desired position within the movement area 58, as will be described in further detail below.

FIGS. 3A-3E show more details related to the pivoting and traversing capability of the jetting system 12. As briefly described above, when the jetting system 12 is not in use, such as when the combination vehicle 10 is travelling on the road, the hose reel 30 is located in a stowed position, as shown in at least FIGS. 1-3A. When so positioned, the slide carriage 36 is positioned to one side of the frame 34, and the hose reel frame 28 pivoted to a position where the hose reel 30 and hose reel frame 28 are adjacent to, and generally extending along, the frame 34. When in the stowed position, the hose reel 30 is generally centered on the front end 38 of the vehicle 10.

With continued reference to FIGS. 3A-3E, when in use, the jetting system 12 is configured so that the hose reel 30 and hose reel frame 28 may both traverse, in a lateral direction as indicated by directional arrows A1, A2, and pivot, as indicated by arc-shaped directional arrows A3, relative to the combination vehicle 10. More particularly, the slide carriage 36 is capable of traversing a longitudinal length of the frame 34 of the jetting system 12 (e.g., side-to-side) with as little friction as possible while supporting the weight of the hose reel frame 28 and the hose reel 30. The slide carriage 36 is also capable of pivoting the hose reel frame 28 and hose reel 30 about vertical axis B2. More specifically, a first proximal end 64 of the hose reel frame 40 remains relatively stationary at the pivot axis B2, while a second distal end 54 thereof pivots in an arc A3 about the pivot axis B2. In one embodiment, the hose reel 30 and hose reel frame 28 may pivot up to about 210° with respect to axis B2 and the slide carriage 36. Preferably, the hose reel 26 may pivot about 180° with respect to axis B2 and the slide carriage 36.

FIG. 3B shows the hose reel frame 28 and hose reel 30 in a stowed position and FIG. 3C shows the hose reel frame 28 and hose reel 30 in a right-most position. To move the hose reel 30 from the stowed position, as shown in FIG. 3B, to the right-most position, as shown in FIG. 3C, the slide carriage 36 is moved laterally along the frame 34, as indicated by directional arrow A1. The hose reel frame 28 may need to be pivoted if the hose reel frame 28 is being moved to the right-most position from a prior position other than the stowed position, for example. When the hose reel frame 28 is in the right-most position, as shown in FIG. 3C, the hose reel frame 28 is positioned on a right side 66 (i.e., passenger side or curb side) of the combination vehicle 10 with the hose reel frame 28 positioned such that the distal end 54 of the hose reel frame 28 and part of the hose reel 30 extend beyond the right side 66 of the combination vehicle 10. The right side 66 of the vehicle 10 may alternatively be referred to as a first side of the vehicle 10.

FIG. 3D shows the hose reel frame 28 and hose reel 30 in a left-most position. To move the hose reel frame 28 and hose reel 30 from the stowed position, as shown in FIG. 36, to left-most position, as shown in FIG. 3D, the slide carriage 36 is moved laterally along the frame 34, as indicated by directional arrow A2. Simultaneously, or separately, the hose reel frame 28 is pivoted, as indicated by directional arrow A3. The hose reel frame 28 may need to be pivoted 180°, for example. When the hose reel frame 28 is in the left-most pivoted position, as shown, the hose reel frame 28 and hose reel 30 are positioned on a left side 68 (i.e., driver side) of the combination vehicle 10 with the hose reel frame 28 positioned such that the distal end 54 of the hose reel frame 28 and a portion of the hose reel 30 extend beyond the left side 68 of the combination vehicle 10. The left side 68 of the vehicle 10 may alternatively be referred to as a second side of the vehicle 10.

The hose reel frame 28 and hose reel 30 may be moved within the movement area 58 to any intermediate position between the right-most position and the left-most position. For example, FIG. 3E shows one exemplary intermediate position of the hose reel 30 and hose reel frame 28. As shown, the slide carriage 36 is moved to a central location along the frame 34 with the hose reel frame 28 pivoted to be generally perpendicular to the frame 30. Stated another way, the distal end 54 of the hose reel frame 28 is pivoted approximately 90° about axis B2 in a direction away from the frame 34.

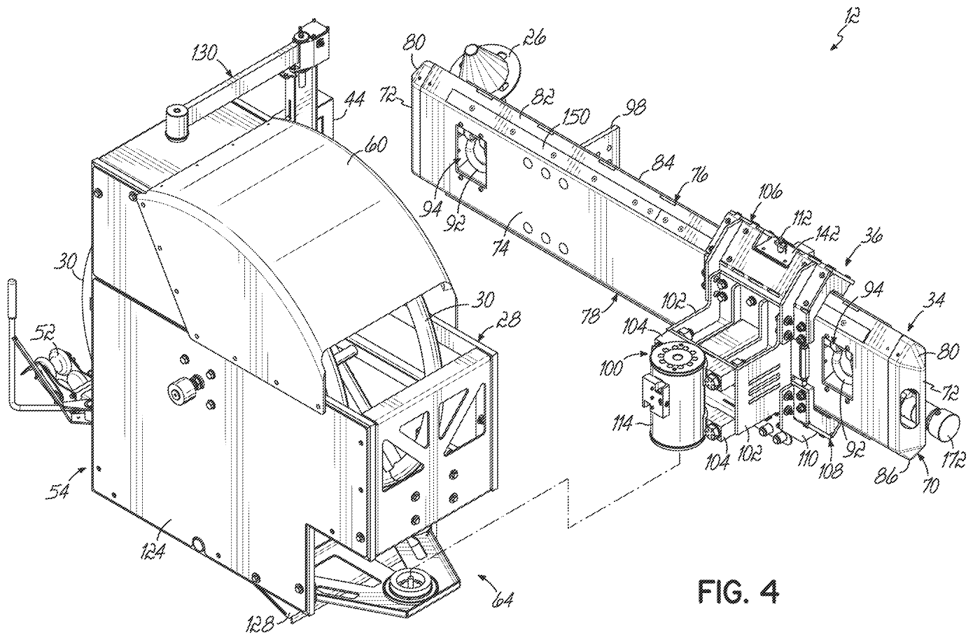

FIGS. 4-10 show the jetting system 12 removed from the combination vehicle 10 for clarity and to show details of the jetting system 12. The jetting system 12 includes the frame 34 that is configured to be attached to the body 16 of the vehicle 10. The jetting system 12 further includes the slide carriage 36 which is movably coupled to the frame 34 and further configured to pivotally support the hose reel frame 28 and hose reel 30 such that the hose reel 30 has both pivotal and traversing capability relative to the frame 34 and the combination vehicle 10. The hose reel frame 28 rotatably supports the hose reel 30 (or hose drum) for storing the high-pressure water supply line 32 or hose (not shown). In one embodiment, components of the jetting system 12, such as the frame 34, slide carriage 38, and hose reel frame 28 may be formed out of structural or sheet aluminum, steel plate, steel sheet, structural steel such as carbon steel, or other suitable material, for example.

As shown in FIGS. 4-6, the frame 34 includes a generally hollow, plate-like body, having a first end 70 and an opposite second end 72. The frame 34 is elongated and has a length (e.g., a distance between the first and second ends 70, 72 of the frame 34) that generally extends between the two sides 66, 68 of the combination vehicle 10 when mounted thereto (e.g., FIG. 2). The frame 34 includes a front plate 74, an upper engagement member 76, and a lower engagement member 78, each of which extends between the first and second ends 70, 72 of the frame 34. The front plate 74, which defines a front surface of the frame 34, extends between the upper and lower engagement members 76, 78 to define a front surface of the frame 34. Hereinafter, the front plate 74 may alternatively be referred to as the front surface of the frame 34. The front plate 74, the upper engagement member 76, and the lower engagement member 78 may be formed from a single piece of material, such as sheet metal, for example, in generally a relatively small C-shape. Each end 70, 72 of the frame 34 includes an end cap 80 which protects and encloses each corresponding end 70, 72 of the frame 34. The upper and lower engagement members 76, 78 and the front plate 74 may be formed from appropriately sized and formed sheet metal, for example.

Each of the upper and lower engagement members 76, 78 is generally triangular in shape and defined by a pair of engagement surfaces 82 that are angled relative to the front plate 74. Further, the upper and lower engagement members 76, 78 define upper and lower edges 84, and 86, respectively, which extend the length of the frame 34. The transverse cross-sectional shape of the frame 34 remains the same along its entire length.

The four opposing angled surfaces of both the upper engagement member 76 and the lower engagement member 78 are used as engagement surfaces 82. Accordingly, and consistent with what is describe above, each engagement surface 82 is angled relative to the front plate 74, preferably at a 45° angle relative to the front surface 74, for example. However, each surface 82 of the upper and lower engagement members 76, 78 may be positioned at other angles relative the front surface 74, such as any angle within the range of between 20° to 70°, for example.

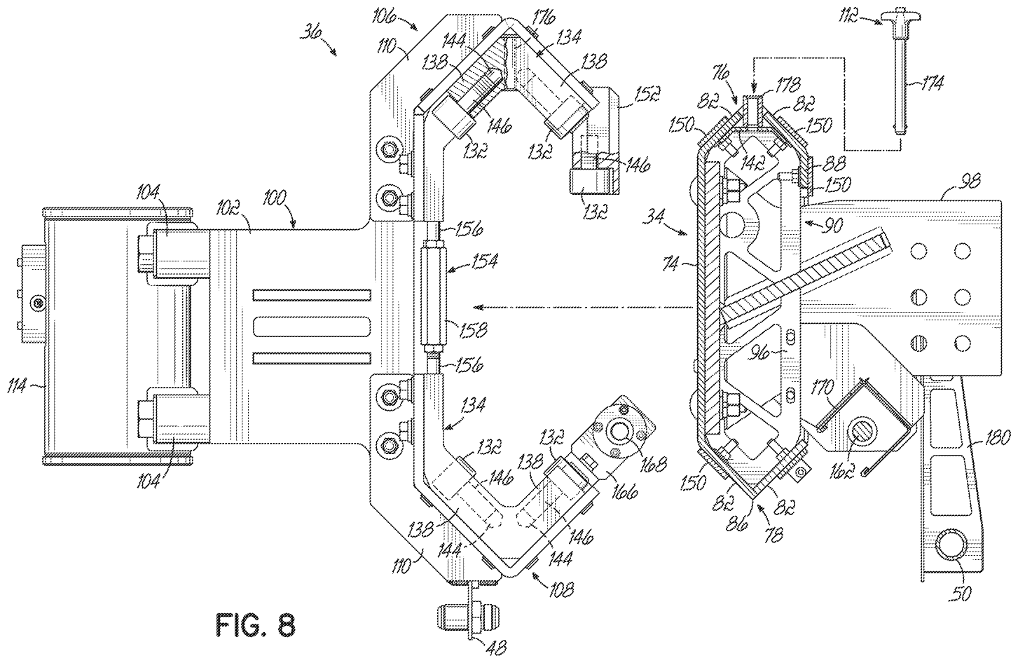

As best shown in FIG. 8, the upper engagement member 76 further includes a stabilizing tab 88 that extends downwardly along a back side 90 of the frame 34 and between the first and second ends 70, 72. In the embodiment shown, the stabilizing tab 88 is an extension of the upper engagement member 76. However, the stabilizing tab 88 may be a separate piece located adjacent the upper engagement member 76. In either case, as will be described in further detail below, the stabilizing tab 88 assists with the traversing motion of the slide carriage 36 and further serves to limit forward motion (i.e., torsion) of the entire assembly about the front end 38 of the vehicle 10.

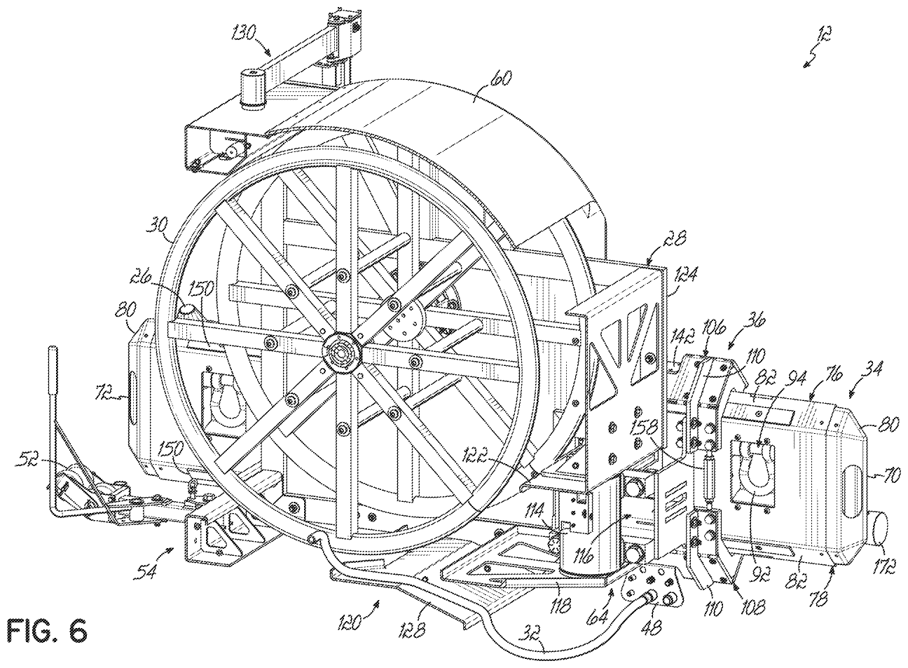

As shown in FIG. 6, the front plate 74 of the frame 34 preferably includes pair of tow rings 92 which are spaced apart along a length of the frame 34, with one tow ring 92 located near the first end 70 and the other tow ring 92 is located closer to the second end 72. More particularly, each tow ring 92 is recessed into a pocket 94 that locates the respective tow ring 92 within the body of the frame 34 and out of the movement path of the slide carriage 36. Each tow ring 92 is accessible via an opening to each pocket 94 located in the front plate 74 of the frame 34.

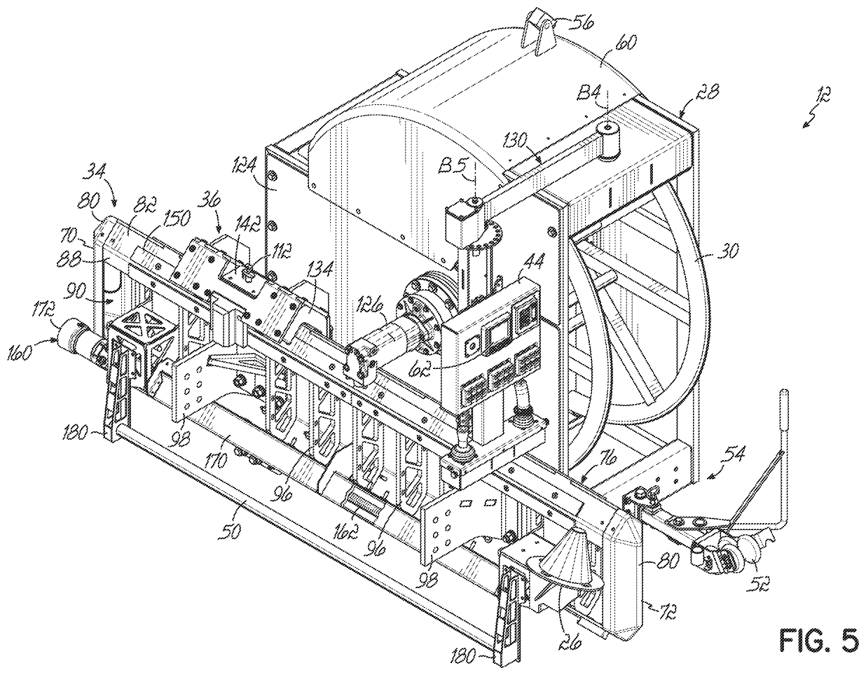

With reference to FIG. 5, the back 90 of the frame 34 is open to a generally hollow interior, or body of the frame 34. Within the interior of the frame 34 are several spaced apart truss-like webs 96 that extend between the lower engagement member 78 and the upper engagement member 76. The front plate 74 of the frame 34 may be attached to each of the webs 96 as well. The webs 96 may be generally plate-like and provide appropriate rigidity and support to the frame 34 to enable the frame 34 to support the traversing and pivotal movements of the hose reel 30 and hose reel frame 28, as well as be supported from the combination vehicle 10. In that regard, the back 90 of the frame 34 includes a pair of plate-like chassis supports 98 that extend from the back 90 of the frame 34 and which are configured to be bolted directly to the body 14 of the vehicle 10 (i.e., frame rails 40) to support the frame 34 therefrom. Each chassis support 98 may be bolted to a corresponding frame rail 40, for example, and includes a varying bolt pattern to allow for adjustability of the frame 34 for use with different sized vehicles. As shown, the chassis supports 98 are spaced apart along the length of the frame 34 and each is attached to a back side of the front plate 74. Each chassis support 98 is attached to the frame 34 with one or more brackets and/or gussets.

The slide carriage 36 is movably coupled to the frame 34 and slideable along the length of the frame 34 and in a lateral direction between the first and second ends 70, 72 of the frame 34 (e.g., side-to-side). More particularly, the slide carriage 36 is mounted to the frame 34 for sliding along the length of the frame 34 while also pivotally supporting the hose reel frame 28 and hose reel 30 from the frame 34. As shown in FIGS. 4-6, the slide carriage 36 includes a body 100 that is generally square or box-like in shape and which comprises two spaced apart vertical support plates 102 between which two horizontal mounting brackets 104 extend. The vertical support plates 102 each span the height of the front surface 74 of the frame 34 and extend between an upper carriage assembly 106 and a lower carriage assembly 108. More particularly, each vertical support plate 102 is coupled (e.g., bolted or welded) at one end to the upper carriage assembly 106 and, at the opposite end, coupled (e.g., bolted or welded) to the lower carriage assembly 108. The slide carriage 36 may include one or more reinforcement members 110 to reinforce the engagement between each vertical support plate 102 and the corresponding upper and lower carriage assemblies 106, 108. The slide carriage 36 further includes a locking mechanism 112 for selectively coupling the slide carriage 36 to the frame 34 to prevent unwanted lateral movement of the slide carriage 36 relative to the frame 34, such as when the vehicle 10 is traveling on a road, for example.

As described above, the slide carriage 36 is configured to pivotally support the hose reel 30 and hose reel frame 28. The slide carriage 36 further includes a rotary actuator 114, such as a counter balance rotary actuator or a rotary actuator and mobile valve with an integrated counter balance, for example, for pivoting the hose reel 30 and hose reel frame 28. The rotary actuator 114 couples to the body 100 of the slide carriage 36 and, more particularly, the horizontal mounting brackets 104. The actuator 114 defines pivot axis B2 of the hose reel frame 28 and is operatively coupled to and driven by the hydraulic unit 42 located on the combination vehicle 10. The actuator 114 is preferably controlled via control assembly 44 and more particularly by a proportional hydraulic valve and CanBus electronic controls, for example. Although the pivoting structure for the hose reel frame 28 is shown and described as being a rotary actuator, it should be understood that other pivoting structures would be possible, such as a gear and chain assembly, a belt sheave assembly, or a rack and pinion assembly, for example.

As shown in FIG. 6, the first proximal end 64 of the hose reel frame 28 is coupled to the slide carriage 36. More particularly, the proximal end 64 of the hose reel frame 28 is coupled to the rotary actuator 114. In this regard, the hose reel frame 28 has a step-shaped profile that forms a notch 116 at the proximal end 64. The actuator 114 is configured to be located within the notch 116 and is sandwiched between a base plate 118 near a base 120 of the hose reel frame 28 and a base 122 of the step-shaped profile of the hose reel frame 28 to permit pivotal movement of the hose reel frame 28 relative to the slide carriage 36 by the actuator 114.

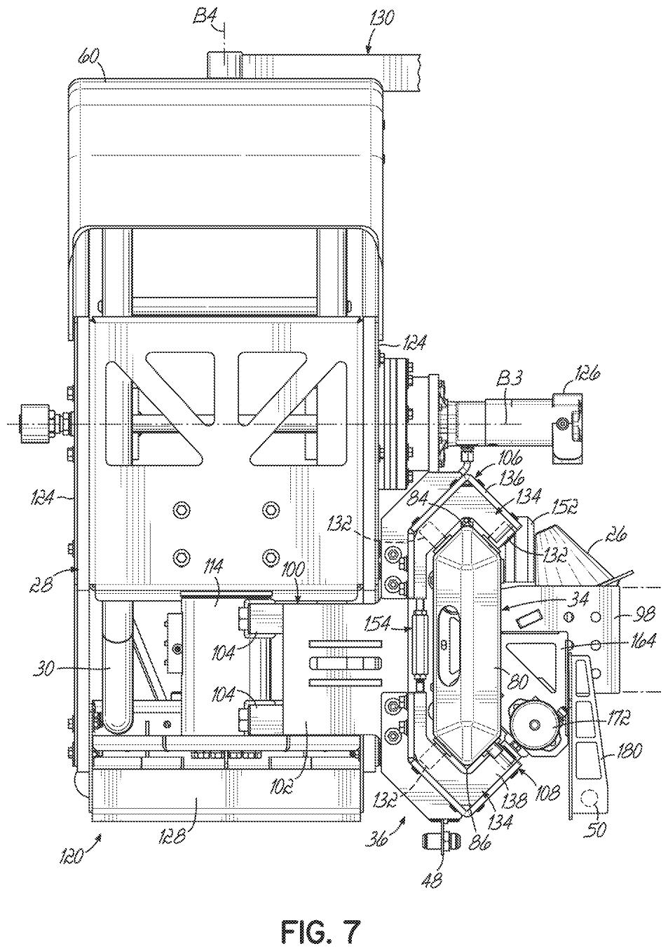

As shown in FIGS. 5 and 6, the hose reel frame 28 extends from the proximal end 64, which is operatively coupled to the slide carriage 36 via the actuator 114, to the second distal end 54, which is open to permit access to the high-pressure water supply hose (not shown) stored on the hose reel 30. The hose reel frame 28 is generally sized to cradle the hose reel 30 and includes two sidewalls 124 which operably support the hose reel 30 therebetween. The hose reel frame 28 includes a drive 126 coupled to one sidewall 124 and operative to rotate the hose reel 30 about rotational axis B3 defined by the drive 126 (e.g., FIG. 7). The drive 126 may be a hydraulic or pneumatic drive. The cover 60 is coupled to the sidewalls 124 of the hose reel frame 28 to generally enclose the hose reel 30 within the hose reel frame 28. The cover 60 may be formed from fiberglass or other suitable lightweight material.

The base 120 of the hose reel frame 28 includes a hose tray 128 configured to direct the water supply line 32, which may be part of a bundle of supply lines including hydraulic supply lines and pneumatic supply lines, from the hose reel frame 28 and toward the vehicle 10. More particularly, the water supply line 32 is supported off the ground by the hose tray 128 and routed a distance from the hose reel frame 28 to the bulkhead plate 48. As described in further detail below, the water supply line 32 is routed from the hose reel frame 28 through the bulkhead plate 48 and over the hose bundle support rod 50.

With continued reference to FIGS. 5 and 6, the jetting system 12 includes the control assembly 44 which is configured to control the traversing and pivoting movements of the hose reel frame 28 relative to the vehicle 10, as well as the rotational movement of the hose reel 30 to reel in or reel out the water supply line 32. The control assembly 44 operatively couples to the hose reel frame 28 via a series of linkages which form a pivotable support arm 130, referred to as a swing arm. The support arm 130 is generally L-shaped and defines a first pivot axis B4 at a first joint and a second pivot axis B5 at a second joint for the control assembly 44 (e.g., FIG. 5). The support arm 130 is configured to space the control assembly 44 away from the hose reel frame 28 and permits pivotable movement of the control assembly 44 about the hose reel frame 28. The control assembly 44 may be pivoted independently about both the first pivot axis B4 and the second pivot axis B5. Further, the control assembly 44 may be raised and lowered using the support arm 130 which permits vertical movement of the control assembly 44 along axis B4. That way, the control assembly 44 can be moved from a stowed position (e.g., FIG. 5) to a desired location and orientation during jetting operations. For example, the control assembly 44 may be pivoted to a position away from the hose reel 30 and near the manhole of the sewer system to be cleaned. That way, an operator can control the jetting system 12 while also observing jetting operations within the manhole. Movement of the control assembly 44 about one or both pivot axes B4, B5 may be motorized or manual. Further, the control assembly 44 may be locked in place once moved to a desired position and orientation, to thereby prevent any unwanted movement of the control assembly 44 during jetting operations.

The control assembly 44 operatively couples to appropriate components of the vehicle 10, such as the jetting pump 30 and a hydraulic unit 42, and the respective drives for the slide carriage 36, hose reel 30, and hose reel frame 28, to thereby control operation of the jetting system 12. The control assembly 44 includes at least one HMI 62 for displaying operational parameters of the jetting system 12, such as positioning and water flow rate. The control assembly 44 further includes one or more keys, gauges, and/or buttons, for interacting with the HMI 62 such as to enter data, view data, change between water flow rates, and reel in/out the water supply hose 32. The control assembly 44 also includes one or more joysticks for controlling movement of the hose reel frame 28 and hose reel 30. The control assembly 44 may include other components to operate and monitor jetting system 12 operations as would be recognized by those skilled in the art.

With reference to FIGS. 7-9, the slide carriage 36, and more particularly the upper and lower carriage assemblies 106, 108 operatively engage the frame 34 to support the slide carriage 36, the hose reel 30, and the hose reel frame 28 therefrom, extending outwardly from the vehicle 10. Specifically, the slide carriage 36, in transverse cross-sectional shape, defines a relatively large C-shape, with the upper and lower carriage assemblies 106, 108 sized and shaped to enable coupling to the frame 34 to thereby enable lateral movement of the slide carriage 36 along the frame 34. As described in further detail below, the upper carriage assembly 106 includes a set of, or a plurality of, roller bearings 132 that are configured to engage the upper engagement member 76 so as to permit lateral movement of the upper carriage 106 therealong. Similarly, the lower carriage assembly 108 also includes a plurality of bearings 132 that are configured to engage with the lower engagement member 78 so as to permit lateral movement of the lower carriage 108 therealong. Each set of bearings 132 engages one of the engagement surfaces 82.

The upper carriage assembly 106 has a generally triangular or L-shaped profile that conforms with, or is complementary to, the triangular shape of the upper engagement member 76. More particularly, the upper carriage assembly 106 includes two “L” shaped blocks 134 which are coupled together in a spaced apart relationship along the upper edge 84 of the frame 34 with an L-shaped bracket 136. Each block 134 is defined by two legs 138, each of which is configured to house one bearing 132, as described in further detail below. The bracket 136 includes a notch 140 located between the two spaced apart blocks 134. The notch 140 includes a plate-like cross-member 142 through which the locking mechanism 112 is inserted to couple the slide carriage 36 to the frame 34, as described in further detail below.

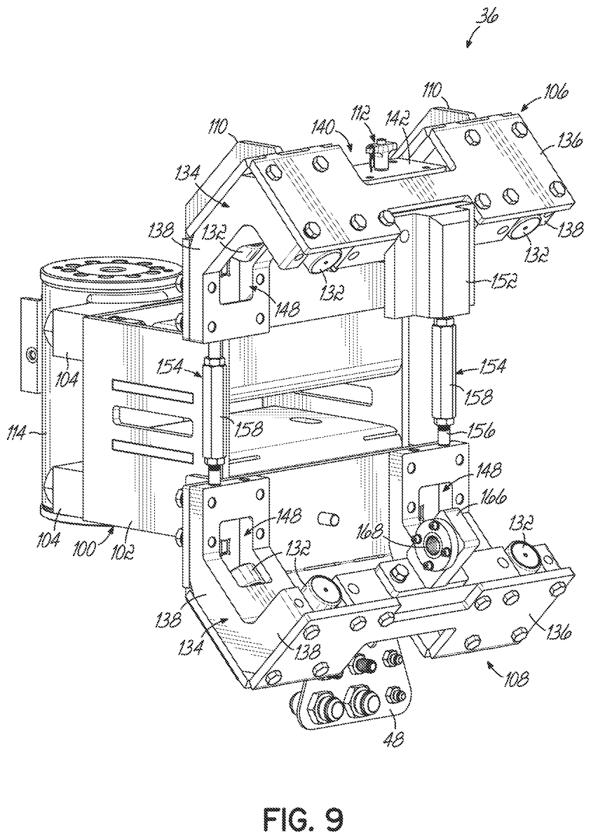

As shown in FIGS. 8-9, each of the two blocks 134 of the upper carriage assembly 106 houses two bearings 132. Thus, the upper carriage assembly 106 houses a total of four bearings 132 configured to engage with the upper engagement member 76. One bearing 132 is located within each leg 138 of the two blocks 134. As shown in FIG. 8, each leg 138 includes a threaded bore 144 configured to threadably receive a bearing axle 146 therein, and an opening 148 configured to receive one bearing 132 therein. The axle 146 extends into the opening 148 and the bearing 132 is operatively coupled to the axle 146 so as to rotate within the opening 148 formed in the leg 138. Each bearing axle 146 extends generally parallel to the corresponding engagement surfaces 82 of the upper engagement member 76 and may be centered, or slightly offset, within the leg 138 to position the bearing 132 in engagement with the upper engagement member 76 to roll therealong. Each bearing axle 146 defines an axis of rotation for each bearing 132. As shown in FIG. 7, each bearing axle 146 and thus the axis of rotation for each bearing 132 is positioned approximately at a 45° angle relative to the front surface 74 of the frame 34. In the embodiment shown, each engagement surface 82 of the upper engagement member 76 includes one or more strips of reinforcing material 150 along which the bearings 132 may roll.

With reference to FIGS. 7-9, the upper carriage assembly 106 also includes a stabilizer 152 that houses a stabilizing bearing 132 configured to engage with the stabilizing tab 88 on the back side 90 of the frame 34 to assist with traversing motion of the slide carriage 36 and to limit forward motion (i.e., torsion) of the entire assembly (slide carriage 36, hose reel frame 28, and hose reel 30) about the front end 38 of the vehicle 10. The stabilizer 152 may be formed from a block of machined material, such as aluminum or steel, and be configured to house at least one bearing 132 therein. In this regard, the stabilizer 152 includes an axle 146 configured to operatively support the bearing 132 such that the bearing 132 may rotate within the stabilizer 152. The stabilizer 152 is coupled to the upper slide carriage 106 to position the bearing 132 in engagement with the stabilizing tab 88 to roll therealong. An axis of rotation of the bearing 132, defined by the axle 146, is generally in parallel with the front surface 74 of the frame 34. The stabilizing tab 88 also includes one or more strips of reinforcing material 150 along which the bearing 132 may roll.

The lower carriage assembly 108 generally has a similar configuration to the upper carriage assembly 106. In this regard, the lower carriage assembly 108 has a generally triangular or L-shaped profile that conforms to, or is generally complementary with, the triangular shape of the lower engagement member 78. More particularly, the lower carriage assembly 108 includes two “L” shaped blocks 134 which are coupled together in a spaced apart relationship along the lower edge 84 of the frame 34 with an L-shaped bracket 136. Each block 134 is defined by two legs 138, perpendicularly oriented, each of which is configured to house one bearing 132, as described in further detail below. The bracket 136 also includes a notch 140 located between the two spaced apart blocks 134 to receive a plate-like cross-member 142 therein. The cross-member 142 provides structural reinforcement for the lower carriage assembly 108.

As shown in FIGS. 7-9, each of the two blocks 134 of the lower carriage assembly 108 houses two bearings 132. Thus, the lower carriage assembly 108 also houses a total of four bearings 132 configured to engage with the lower engagement member 78. In this regard, one bearing 132 is located within each leg 138 of the two blocks 134. Each leg 138 includes a threaded bore 144 configured to threadably receive a bearing axle 146 therein, and an opening 148 configured to receive one bearing 132 therein. The axle 146 extends into the opening 148 and the bearing 132 is operatively coupled to the axle 146 so as to rotate within the opening 148 formed in the leg 138. The bearing axle 146 extends generally parallel to the corresponding lower engagement surface 82 and may be centered, or slightly offset, within the leg 138 to position the bearing 132 in engagement with the lower engagement member 78 to roll therealong. The bearing axle 146 defines an axis of rotation for each bearing 132. To this end, each bearing axle 146 and thus the axis of rotation for each bearing 132 is positioned approximately at a 45° angle relative to the front surface 74 of the frame 34. In the embodiment shown, the engagement surfaces 82 of the lower engagement member 78 each include one or more strips of reinforcing material 150 along which the bearings 132 may roll.

The slide carriage 36 further includes a pair of tensioners 154 operable to adjust the relative vertical positions of the upper and lower slide carriages 106, 108, thereby to accommodate the frame 34. As shown in FIG. 9, each tensioner 154 extends between a corresponding block 134 of the upper and lower slide carriages 106, 108. More particularly, a portion of the front-facing leg 138 of each block 134 includes a threaded rod 156 to which a coupling nut 158 is threaded. The coupling nut 158 is threaded to each rod 156 and extends between the rods 156 to form the tensioner 154. The coupling nut 158 is threaded in one direction to move the corresponding legs 138 and ultimately the upper carriage assembly 106 closer to the lower carriage assembly 108. The coupling nut 158 is threaded in an opposite direction to move the corresponding legs 138 apart, and ultimately the upper carriage assembly 106 away from the lower carriage assembly 108.

The upper and lower carriage assemblies 106, 108 guide the traversing movement of the slide carriage 36 across the frame 34. Although the structure for moving described above with respect to the upper and lower carriage assemblies 106, 108 is in the form of bearings, or cam rollers, other structure may be used for causing this movement, such as complementary wear surfaces and a lubricant, for example. In either case, the jetting system 12 further includes a driver, preferably in the form of a hydraulically driven lead screw system 160, for driving the traversing movement of the slide carriage 36 across the frame 34.

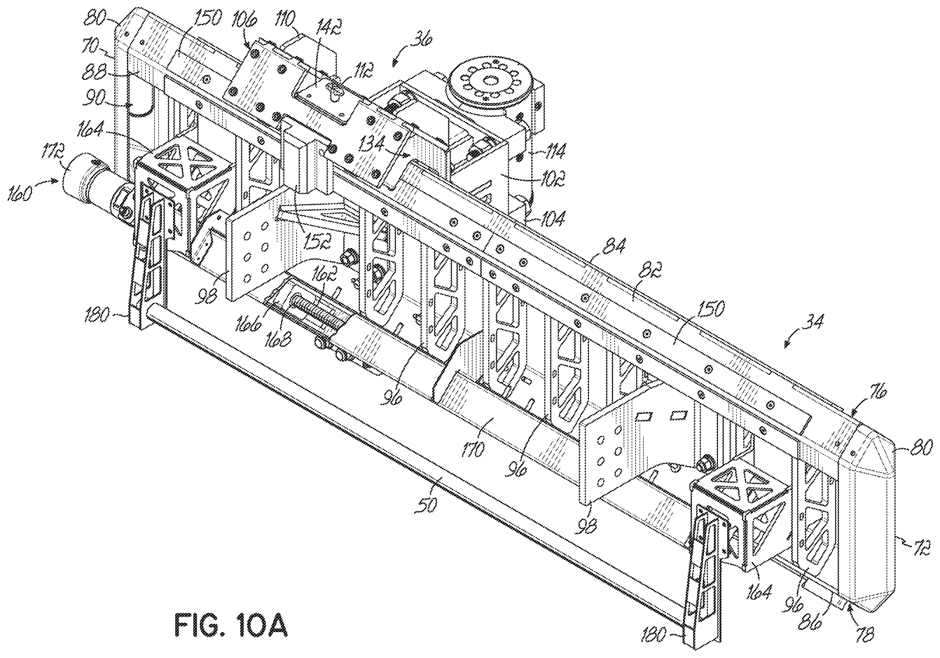

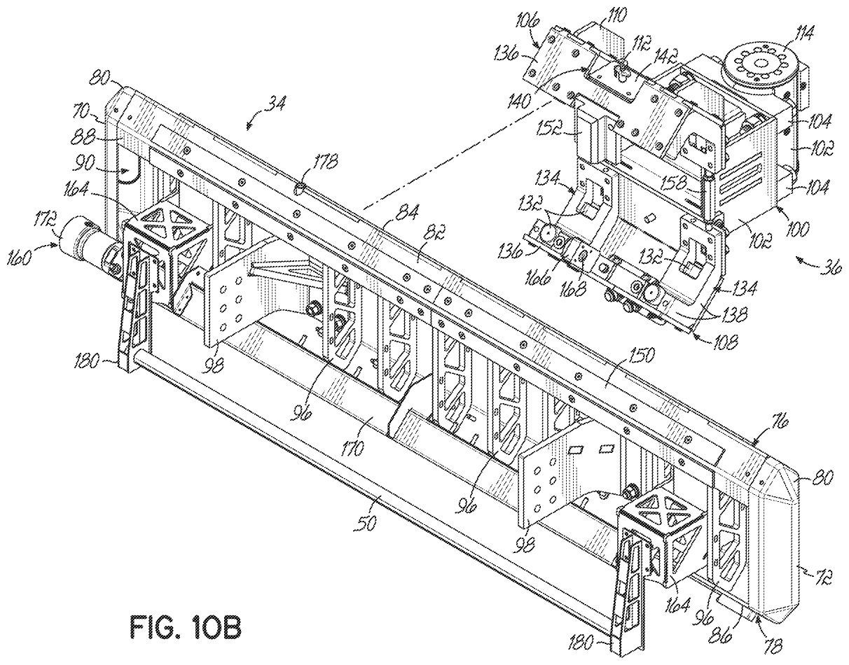

More particularly, as best shown in FIGS. 10A-10B, the lead screw system 160 includes a lead screw 162 operatively coupled between two support blocks 164 extending from the back 90 of the frame 34. In this regard, the lead screw 162 generally extends the length of the frame 34. The lower carriage assembly 108 operatively couples to the lead screw 162 via a block 166 having a threaded bore 168. More particularly, the lead screw 162 extends through the threaded bore 168 in the block 166 such that rotational movement of the lead screw 162 results in movement of the block 166 and the lower carriage assembly 108. The lead screw system 160 includes a protective guard 170 for the lead screw 162 to prevent dirt and other contaminants from binding or damaging the screw 162. The guard 170 is coupled between the support blocks 164 and partially encloses the screw 162. The guard 170 may extend about three quarters of the screw 162, for example, while still allowing the block 166 to be moved along a length of the screw 162.

The lead screw system 160 further includes a drive 172, such as a hydraulic, pneumatic, or electrically driven actuator or motor, operatively mounted to one support block 164 to rotate the screw 162 to drive lateral movement of the slide carriage 36 relative to the frame 34. Thus, as the drive 172 rotates the lead screw 162 in one direction, the slide carriage 36 traverses the frame 34 in a first direction (e.g., A1 in FIG. 3A). Reversing the direction of rotation of the lead screw 162 causes the slide carriage 36 to traverse the frame 34 in an opposite direction (e.g., A2 in FIG. 3A). Operation of the lead screw 162 and thus traversing motion of the slide carriage 36 may be controlled via the control assembly 44 and more particularly a proportional hydraulic valve and CanBus electronic controls, for example. Although the driver is shown and described as being a hydraulically driven lead screw system, other types of driver mechanisms would also be possible, such as a rack and pinion system, one or more hydraulic cylinders, or a magnetic levitation system, for example.

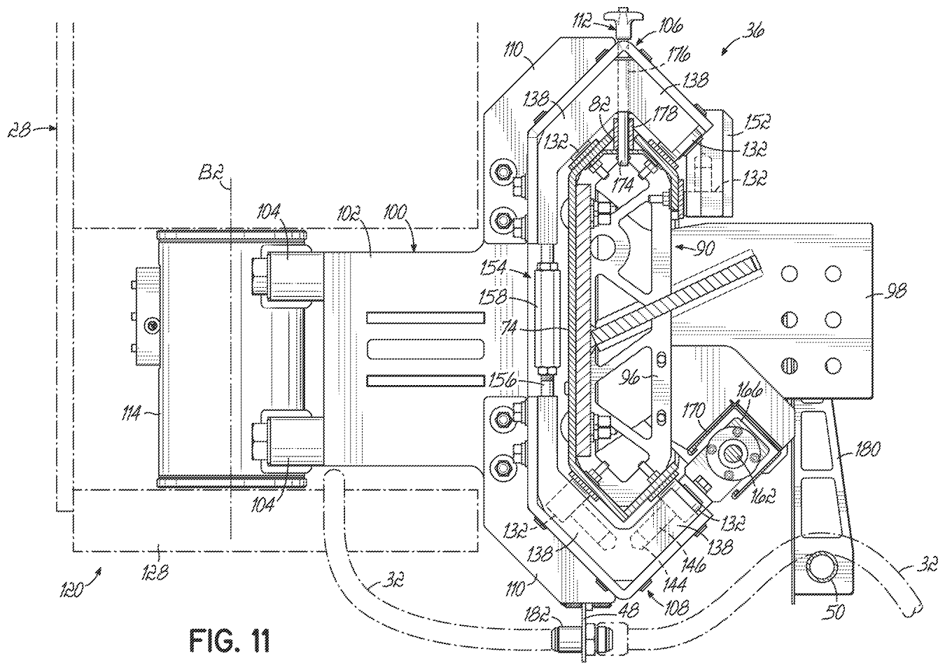

As described above, to prevent movement of the slide carriage 36 along the frame 34, the slide carriage 36 includes the locking mechanism 112. As shown in FIG. 11, the locking mechanism 112 includes a pin body 174 configured to engage portions of the slide carriage 36 and the frame 34. The locking mechanism 112 may be a T-handle quick release ball lock pin, for example. The upper carriage assembly 106 includes a tubular member 176 that extends from the cross-member 142 in a direction toward the upper edge 84 of the frame 34. The frame 34 includes a similarly sized tubular member 178 having an opening in the upper edge 84 of the frame 34 near the first end 70 of the frame 34. When the slide carriage 36 is appropriately positioned, the tubular members 176, 178 align so that the pin body 174 of the locking mechanism 112 may be received therethrough to lock the slide carriage 36 in place relative to the frame 34.

As described above, the jetting system 12 includes the bulkhead plate 48 and the hose bundle support rod 50 to support the water supply line 32 above the ground and to prevent the water supply line 32 from becoming tangled, kinked, or otherwise damaged during the pivoting and traversing movements of the hose reel 30. As shown in FIGS. 10A-10B, the hose bundle support rod 50 is coupled to the support blocks 164 with a pair of brackets 180. The support rod 50 has a length that is similar to, or slightly less than, the length of the frame 34. As shown in FIG. 11, the brackets 180 position the support rod 50 generally in line with the lower edge 86 of the frame 34.

With continued reference to FIG. 11, the bulkhead plate 48 couples to the lower carriage assembly 108 and extends a distance in a downward direction from the lower carriage assembly 108 (e.g., in a direction away from the frame 34). The bulkhead plate 48 includes a plurality of fittings 182 configured to receive corresponding supply lines, such as the water supply line 32 and one or more pneumatic and/or hydraulic supply lines, as they are routed from the hose reel frame 28 to the vehicle 10. The one or more fittings 182 are used to make the appropriate supply line connections at the bulkhead plate 48. Alternatively, the water supply line 32 and other supply lines could be routed through corresponding openings in the bulkhead plate 48. In any event, the bulkhead plate 48 traverses the frame 34 with the carriage 36 and, as a result, a minimal amount of water supply line 32 slack is needed between the bulkhead plate 48 and the hose reel frame 34 to permit pivotal movement of the hose reel frame 34.

The bundle of supply lines, including the water supply line 32, extending from the bulkhead plate 48 is routed from the bulkhead plate 48 to appropriate connections on the vehicle 10, and is further supported off the ground by the hose bundle support rod 50. Thus, as the hose reel frame 28 and carriage 36 traverse the frame 34, the water supply line 32 slides across the support rod 50. To reduce wear on the water supply line 32 from this movement, the water supply line 32 may be wrapped in plastic sheathing or a plastic guide. The hose bundle support rod 50 may be formed from aluminum, or any other suitable metal, for example.

In operation, a user drives the combination vehicle 10 equipped with the jetting system 12 to a location with a sewer, i.e., a manhole, to be jetted. The user parks the vehicle 10 such that the manhole is near, or within, the movement area 58 as seen on an HMI display 62 of a vision system that is part of the jetting system 12. The user then will then need to move the distal end 54 of the hose reel frame 28, where the nozzle of the water supply line 32 is located, near or over the manhole, for jetting operations.

More specifically, the user first removes the locking mechanism 112 from the slide carriage 36 to free the slide carriage 36 from the frame 34. Next, the user pivots the control assembly 44 from the stowed position (e.g., FIG. 1) to a position in front of the vehicle 10. Using the control assembly 44, the user causes the hose reel frame 28 to traverse across the front of the vehicle 10 to a desired position, and/or causes the hose reel frame 28 to pivot relative to the front end 38 of the vehicle 10, to thereby locate the distal end 54 of the hose reel frame 28 over the manhole. As described above, this traversing movement occurs via a lead screw drive system 160 mounted on the frame 34, and this pivoting movement occurs via operation of a hydraulic actuator 114 mounted on the slide carriage 36. Once the distal end 54 of the hose reel frame 28 has been located over the manhole, the user operates the control assembly 44 to rotate the hose reel 30 to move the water supply line 32 in to or out of the manhole, for jetting operations.

After jetting operations are finished, the user operates the control assembly to rewind the hose 32 on the hose reel 30. The user then moves the hose reel frame 28 back to its stowed position, traversed to the front left end of the frame 34 and pivoted into alignment with the front of the vehicle 10. The user then reinstalls the locking mechanism 112 to secure the slide carriage 36 to the frame 34, to thereby place the jetting system 12 in a condition for transportation by the vehicle 10.

This specification discloses a currently preferred embodiment of the present invention. It should be understood that this specification is not intended to be limiting. For example, although this specification discloses the pivotal traversing structure located at the front end of a vehicle, it could also be located at the rear end, or even mounted at either end of some other type of vehicle, or even a trailer. In any event, a person skilled in the art will recognize that various modifications, alterations, and adaptations may be made to the disclosed embodiments without departing from the scope of the invention. Further, those skilled in the art will recognize that not every claim is intended to recite an invention that achieves all of the advantageous features described herein. Accordingly, for each of the numbered claims below, the scope of the invention as recited therein should be determined in accordance with the actual words in the claim itself, and not by importing into the claim any unnecessary details from this disclosure.

We claim:

1. A combination vehicle for cleaning a sewer, the vehicle including a water jetting system comprising:
a frame mounted to a first end of the vehicle and horizontally spanning substantially a width thereof;
a slide carriage operatively engaged with the frame and slideable therealong, across the width of the vehicle;
a hose reel frame pivotally connected to the slide carriage and pivotal about a vertical axis;
a hose reel rotatably supported on the hose reel frame, adapted to rotate about a horizontal axis, and configured to support a hose that is operatively connectable to a water jetting source to thereby supply pressurized water from an outer end of the hose; and
a controller operatively coupled to the hose reel frame and operable to cause traversing of the slide carriage along the frame, and also operable to cause pivotal movement of the hose reel frame relative to the vertical axis and the slide carriage, thereby to enhance the capability for locating the hose in a desired position for cleaning a sewer.

2. The combination vehicle of claim 1, wherein the hose reel frame includes a proximal end and an opposite distal end, and further comprising:
an actuator located on the slide carriage and pivotally connected to the hose reel frame, the actuator defining the vertical pivot axis of the hose reel frame.

3. The combination vehicle of claim 2, wherein the distal end of the hose reel frame is selectively movable beyond either a left side or a right side of the combination vehicle.

4. The combination vehicle of claim 1, and further comprising:
a driven lead screw located on the frame and configured to engage the slide carriage to move the slide carriage along the frame.

5. The combination vehicle of claim 1, and further comprising:
a vision system with an operatively connected display supported by the slide carriage, the vision system operates to sense and display movement of the hose reel frame relative to the first end of the vehicle

6. The combination vehicle of claim 1, and further comprising:
a swing arm located on the hose reel frame and supporting the controller, the swing arm permitting horizontal and vertical movement of the controller relative to the hose reel frame.

7. The combination vehicle of claim 1, and further comprising:
a locking mechanism supported by the hose reel frame and operable to lock the slide carriage in place relative to the frame.

8. The combination vehicle of claim 1, and further comprising:
an upper carriage assembly located on the slide carriage;
an upper engagement member located on the frame, the upper carriage assembly configured to engage with and move along the upper engagement member; and
a lower carriage assembly configured to engage with and move along a corresponding lower engagement member of the frame.

9. The combination vehicle of claim 8, wherein each of the upper carriage assembly and the lower carriage assembly operatively supports a plurality of rollers, and each plurality of rollers operatively engages one of the upper and lower engagement members.

10. The combination vehicle of claim 9, wherein an axis of rotation for each of the plurality of rollers of the upper and lower carriage assemblies is angled relative to a front surface of the frame.

11. The combination vehicle of claim 8, wherein the upper carriage assembly includes a stabilizing roller operatively engaged with a back surface of the frame.

12. The combination vehicle of claim 11, wherein an axis of rotation of the stabilizing roller is in parallel with a front surface of the frame.

13. The combination vehicle of claim 1, and further comprising:
at least one tensioner located on the slide carriage and configured to adjust a position of the slide carriage relative to the frame.

14. The combination vehicle of claim 1, and further comprising:
a bulkhead plate mounted on the slide carriage, the hose being coupled to the bulkhead plate between the hose reel and the water jetting source.

15. The combination vehicle of claim 14, further comprising:
a hose tray mounted on the hose reel fame to support the hose enroute from the hose reel frame to the bulkhead plate.

16. The combination vehicle of claim 1, and further comprising:
a hose bundle support rod mounted on the frame, and configured to continually support the hose as the slide carriage traverses the frame.

17. A jetting system for a vehicle with a jetting pump, comprising:
a frame configured to be coupled to the vehicle;
a slide carriage operatively engaged with the frame and slideable along a length thereof;
a hose reel frame pivotally connected to the slide carriage about a pivot axis; and
a hose reel rotatably supported on the hose reel frame and configured to support a hose connected to the jetting pump; and
wherein the hose reel frame is movable linearly relative to the frame in first or second direction relative to the vehicle, and
also pivotally movable about the pivot axis relative to the slide carriage.

18. The jetting system of claim 17, further comprising:
a controller operatively coupled to the hose reel frame and operable to maneuver the slide carriage, the hose reel, and the hose reel frame.

19. The jetting system of claim 17, and further comprising:
upper and lower carriage assemblies mounted on the slide carriage; and
corresponding upper and lower engagement members located on the frame, the respective upper and lower carriage assemblies configured to engage with and move along the upper and lower engagement members.

20. The jetting system of claim 17, and further comprising:
the slide carriage defining generally a C-shape in cross section, with upper and lower carriage assemblies partially surrounding corresponding respective upper and lower engagement members of the frame, the frame being elongated and of uniform cross sectional shape along the entire length thereof, the slide carriage and the frame thereby defining four distinct engagement surfaces for guiding the traversing movement of the slide carriage relative to the frame.
